(19) United States
(12) Patent Application Publication
(10) Pub. No.: US 2026/0321239 A1
(43) Pub. Date: Oct. 15, 2026

(54) COMPONENT FOR MANIPULATING AN INPUT SHOCKWAVE

(71) Applicant: First Light Fusion Limited, Yarnton, Oxfordshire (GB)

(72) Inventors: Matthew Betney, Yarnton, Oxfordshire (GB); Mila Fitzgerald, Yarnton, Oxfordshire (GB); Thomas Edwards, Yarnton, Oxfordshire (GB); James Parker, Yarnton, Oxfordshire (GB); Jonathan Skidmore, Yarnton, Oxfordshire (GB); Nicolas Niasse, Yarnton, Oxfordshire (GB)

(21) Appl. No.: 19/483,004

(22) PCT Filed: May 16, 2024
(86) PCT No.: PCT/GB2024/051282

§ 371 Date: Nov. 10, 2025

(30) Foreign Application Priority Data
May 17, 2023 (GB) 2307373.7

(51) Int. Cl. G10K 11/28; G10K 11/02; G10K 15/04; G21B 3/00

(52) U.S. Cl. CPC G10K 11/28; G10K 11/02; G10K 15/043; G21B 3/008

(57) ABSTRACT

A component for manipulating an input shockwave. The component includes a body made from a first material and a volume defined within the body for manipulating the input shockwave to produce a manipulated shockwave. The volume includes an input for receiving the input shockwave incident upon the component, an output for outputting the manipulated shockwave from the volume, and multiple layers between the input and the output. The layers include one or more layers made from a second material that is different from the first material. The layers include one or more layers having an input face and/or an output face with a non-planar portion.

### CROSS-REFERENCE TO RELATED APPLICATION(S)

This application is the U.S. national phase under 35 U.S.C. § 371 of International Application No. PCT/GB2024/051282 filed on May 16, 2024, and claims the benefit of United Kingdom Patent Application No. 2307373.7 filed on May 17, 2023, wherein the entire disclosures of the foregoing applications are hereby incorporated by reference herein.

### TECHNICAL FIELD

This invention relates to a component for manipulating an input shockwave, in particular to methods and apparatuses for producing high localised concentrations of energy by manipulating an input shockwave to produce a high pressure quasi-spherical shockwave.

### BACKGROUND

It has been shown in WO 2011/138622 that an interaction between a shockwave in a non-gaseous medium and a gaseous medium can generate a high speed transverse jet of the non-gaseous medium that moves through the gaseous medium. This results in the jet impacting on and trapping a volume of the gaseous medium, e.g. against a target, which gives rise to an intense concentration of energy within the gas.

The present invention aims to provide alternative techniques for producing localised energy concentrations.

### SUMMARY

When viewed from a first aspect, the invention provides a component for manipulating an input shockwave, wherein the component comprises:
a body comprising a first material;
a volume defined within the body, wherein the volume is configured to manipulate the input shockwave so as to produce a manipulated shockwave;
   wherein the volume comprises:
      an input for receiving the input shockwave incident upon the component;
      an output for outputting the manipulated shockwave from the volume; and
      a plurality of layers between the input and the output;
         wherein the plurality of layers comprises one or more layers comprising a second material that is different from the first material; and
         wherein the plurality of layers comprises one or more layers having an input face and/or an output face comprising a non-planar (e.g. curved) portion.

The invention thus provides a component that manipulates a shockwave, when the shockwave is input into the component. The component has a body that comprises (e.g. is formed from) a first material, and the body is shaped to define a volume. The volume has an input (e.g. aperture) designed to receive the (input) shockwave that is incident upon the input of the volume. The volume is designed (e.g. shaped) to manipulate the shockwave as it passes through the volume. The volume also has an output (e.g. aperture) designed to output the manipulated shockwave.

Thus, the volume is defined within (e.g. through) the body. For example, the body comprises one or more (e.g. internal) walls that define the volume. Such walls may help to manipulate the input shockwave as it passes through the volume.

The volume comprises (e.g. contains) a plurality of layers, e.g. defined or provided within the volume. One of more of these layers comprises (e.g. is formed from) a second material. The second material is different from the first material of the body. One of more of the layers (which may or may not be the layer or layers that comprises the second material) has an input and/or output face having a non-planar (e.g. curved) portion, i.e. a portion of the input and/or output face of at least one of the layers is non-planar (e.g. curved), and thus the input and/or output face is not completely flat.

Thus it will be seen that, in at least preferred embodiments, the component can be used to manipulate (e.g. modify the shape and/or intensity of) an input shockwave, owing to the (e.g. shape and/or material(s) of the) volume and the (e.g. shape of and/or materials of) the plurality of layers. Providing multiple layers helps to superimpose components of the input shockwave that are reflected from the boundaries (e.g. the respective input and output faces) between the layers. This helps to amplify the intensity of the shockwave between the input and the output of the volume.

As such, the shockwave transmitted from the output of the volume may have a greater (e.g. energy) intensity than the input shockwave received at the input of the volume and/or a different shape from the input shockwave received at the input of the volume. In particular, the one or more layers having an input face and/or output face comprising a non-planar (e.g. curved) portion may help to shape, e.g. (at least partially) spherically focus, the shockwave such that the shockwave transmitted from the output of the volume may be at least partially non-planar, e.g. curved (e.g. spherical). This may help to increase the localised energy concentration of the manipulated shockwave that is output from the volume.

The body is formed from (comprises, e.g. consists of) a first material. The volume contains (e.g. is at least partially filled with) a plurality of layers, one or more these layers being formed from (comprising, e.g. consisting of) a second material. Thus the (shape of the) volume is defined by the (e.g. internal walls of the) body (formed from the first material) and the layers are located within the volume.

In embodiments, the second material has a shock-impedance that is lower than a shock-impedance of the first material. The difference in shock-impedances between the body and at least one of the layers may help to manipulate the shockwave, e.g. by (at least partially) reflecting the shockwave from the walls (e.g. at the boundary between the first and second material).

In embodiments, the plurality of layers comprises one or more layers having a non-uniform (e.g. variable) thickness (e.g. the shortest distance from the input face to the output face of the layer at any given point). Thus, the thickness of one or more of the layers is different at different points over the area of the layer. This means that different portions of a shock-front will spend different lengths of time propagating through these one or more layers. Since the material of the layer may alter the speed of the shockwave, a layer having a non-uniform thickness may alter the shape of the shock-front.

This is considered to be novel and inventive in its own right, and thus, when viewed from a further aspect, the invention provides a component for manipulating an input shockwave, wherein the component comprises:
a body comprising a first material;
a volume defined within the body, wherein the volume is configured to manipulate the input shockwave so as to produce a manipulated shockwave;
   wherein the volume comprises:
      an input for receiving the input shockwave incident upon the component;
      an output for outputting the manipulated shockwave from the volume; and
      a plurality of layers between the input and the output;
         wherein the plurality of layers comprises one or more layers comprising a second material that is different from the first material; and
         wherein the plurality of layers comprises one or more layers having a non-uniform thickness.

It will be appreciated that this aspect may (and preferably does) include one or more (e.g. all) of the preferred and optional features disclosed herein, e.g. relating to other aspects and embodiments of the invention, as applicable. Thus, for example, the plurality of layers may comprise one or more layers having an input face and/or an output face comprising a non-planar (e.g. curved) portion.

The plurality of layers in the volume may be defined by each layer having an input face and an output face. In embodiments, the output face of a layer corresponds to (is contiguous with) the input face of the adjacent layer (and vice versa).

The non-planar (e.g. curved) portion of the input and/or output face of one or more of the plurality of layers may be provided in any suitable and desired way. In embodiments, the plurality of layers comprises one or more layers having an input face comprising a convex portion (when the face is viewed externally). In embodiments, the (e.g. entire) input face may be convex. A layer having an input face comprising a convex portion may help to spherically focus the input shockwave.

In embodiments, a plurality (e.g. each) of the layers have an input face comprising a convex portion. Preferably, the radius of curvature of the convex portions decreases (e.g. progressively) from the input to the output.

In embodiments, the plurality of layers comprises one or more layers having an output face comprising a concave portion (when the face is viewed externally). In embodiments, the (e.g. entire) output face may be concave. A layer having an output face comprising a concave portion may help to spherically focus the input shockwave.

In embodiments, a plurality (e.g. each) of the layers have an output face comprising a concave portion. Preferably, the radius of curvature of the concave portions decreases (e.g. progressively) from the input to the output.

In embodiments, the plurality of layers comprises one or more layers (e.g. each of the plurality of layers) having both an input face comprising a convex portion and an output face comprising a concave portion.

In embodiments the layer (e.g. the output layer) at or adjacent the output of the volume has a non-planar (e.g. curved) output face. In embodiments, the entire output face is curved.

In embodiments, the layer (e.g. the output layer) at or adjacent the output of the volume has an output face comprising a concave portion, such that the volume output comprises a concave portion (when the output is viewed externally). In embodiments, the (e.g. entire) output face is concave. This may help to improve the efficiency of the volume output since the shockwave may be manipulated to become increasingly spherical as it propagates through the component. As such, to help the shocks effectively propagate out of the output, the output face may be similarly curved, such that the output face at any one position is approximately parallel to the shock-front at that position.

In embodiments, the volume output (e.g. the output face of the layer at or adjacent the output) comprises (e.g. is formed as) a spherical section. In embodiments, the volume output (e.g. when formed as a spherical section which, when taken in a cross section that is parallel to a central longitudinal axis of the volume and/or body) extends around greater than 180°. Thus, the volume output may extend around at least a hemisphere, i.e. having a solid angle greater than 21T.

In embodiments, the layer (e.g. the output layer) at or adjacent the output of the volume has an output face comprising a convex portion and/or a flat portion, e.g. instead of or as well as a concave portion. In embodiments, the (e.g. entire) output face is convex. In embodiments, the (e.g. entire) output face is flat (planar).

In embodiments the layer (e.g. the input layer) at or adjacent the input of the volume has a non-planar (e.g. curved) input face. In embodiments, the entire input face is curved. Such embodiments may be used with a projectile (e.g. having a substantially flat impacting surface) that is arranged to strike the (e.g. volume input of the) component to generate a shockwave having a curved shock-front in the (e.g. volume of the) component.

This is considered to be novel and inventive in its own right, and thus, when viewed from a further aspect, the invention provides a component for manipulating an input shockwave, wherein the component comprises:
a body comprising a first material;
a volume defined within the body, wherein the volume is configured to manipulate the input shockwave so as to produce a manipulated shockwave;
   wherein the volume comprises:
      an input for receiving the input shockwave incident upon the component; and
      an output for outputting the manipulated shockwave from the volume;
   wherein the volume contains a second material having a shock-impedance that is different from (e.g. lower than) a shock-impedance of the first material;
   wherein the second material forms an input face at the input of the volume; and
   wherein the input face comprises a non-planar portion.

Providing a second material, having a shock-impedance that is different from (e.g. lower than) the shock-impedance of the material of the body) may help the shockwave to be (at least partially) reflected from the walls of the body (e.g. at the boundary between the first and second material).

It will be appreciated that this aspect may (and preferably does) include one or more (e.g. all) of the preferred and optional features disclosed herein, e.g. relating to other aspects and embodiments of the invention, as applicable.

In embodiments the layer (e.g. the input layer) at or adjacent the input of the volume has an input face comprising a concave portion, such that the volume input comprises a concave portion (when the input is viewed externally). In embodiments, the (e.g. entire) input face is concave. Such embodiments may be used with a projectile (e.g. having a substantially flat impacting surface) that is arranged to strike the (e.g. volume input of the) component to generate a shockwave having a curved shock-front in the (e.g. volume of the) component.

A concave input face may be used with a projectile having a corresponding convex impacting surface that is arranged to strike the (e.g. volume input of the) component such that the impacting surface of the projectile and the input face of the volume are aligned (e.g. the impacting surface is complementary to (e.g. matches) the input face) when the projectile impacts the component. This may help to increase the energy coupling from the projectile into the volume.

In some embodiments, the layer (e.g. the input layer) at or adjacent the input of the volume has an input face comprising a convex portion, such that the volume input comprises a convex portion (when the input is viewed externally). In embodiments, the (e.g. entire) input face is convex. Such embodiments may be used with a projectile that is arranged to strike the (e.g. volume input of the) component to generate a shockwave.

A convex input face may not help to curve the shockwave in the volume, but a convex input face may be less sensitive to the tilt of the projectile (e.g. the projectile not being perfectly aligned with the input face) and so may be preferable to a concave face in systems where the angle of the projectile at the input may be less predictable.

A convex input face may be used with a projectile having a corresponding concave impacting surface that is arranged to strike the (e.g. volume input of the) component such that the impacting surface of the projectile and the input face of the volume are aligned (e.g. the impacting surface is complementary to (e.g. matches) the input face) when the projectile impacts the component. This may help to increase the energy coupling from the projectile into the volume.

In some embodiments, the layer (e.g. the input layer) at or adjacent the input of the volume has an input face comprising a flat (planar) portion. In embodiments, the (e.g. entire) input face is flat (planar). Such embodiments may be configured to be used with a projectile having a non-planar, e.g. curved (e.g. concave or convex) impacting surface that is arranged to strike the (e.g. volume input of the) component to generate a shockwave having a non-planar (e.g. curved) shock-front in the (e.g. volume of the) component.

In embodiments, the layer (e.g. the input layer) at or adjacent the volume input has an output face comprising a concave portion (when viewed externally).

In some embodiments, the plurality of layers have the same form of input faces and/or output faces as each other, e.g. planar, non-planar, concave, convex. In some embodiments, one or more of the plurality of layers has an input face and/or an output that has a different form of input face and/or output face from one or more (e.g. all of) the other(s) of the plurality of layers. For example, the layer at or adjacent the input and/or the output of the volume may have a different form than one or more (e.g. all of) the other(s) of the plurality of layers.

The input and/or output layer(s) of the volume may comprise (e.g. be formed from) any suitable and desired material. In some embodiments, the input and/or output layer(s) comprises a low shock-impedance material, e.g. having a lower shock-impedance material than the first material and/or than the second material. In some embodiments, the input and/or output layer(s) comprises (e.g. is formed from, e.g. consists of) the second material.

In some embodiments, the input and/or output layer(s) comprises a high shock-impedance material, e.g. having a greater shock-impedance material than the second material and/or than the first material. In some embodiments, the input and/or output layer(s) comprises (e.g. is formed from, e.g. consists of) the first material.

In some embodiments the component comprises at least one impedance matching layer adjacent to or at the input of the volume. In some embodiments, the input (layer) of the volume comprises the impedance matching layer.

Providing an impedance matching layer, e.g. matching the impedance of an incident projectile, may help to couple the incident shockwave into the (e.g. volume of the) component. Thus, as outlined above in relation to the input of the volume, the impedance matching layer may be arranged to be impacted by a projectile to generate the input shockwave.

Thus, in some embodiments, the input of the volume is provided by (e.g. an outer surface of) the impedance matching layer, e.g. together with an outer surface of the body. In some embodiments, the impedance matching layer extends across the (e.g. input of the) volume, e.g. between the wall(s) of the body (that form the volume). Thus, the body and/or the impedance matching layer may comprise (e.g. together form) an input face. An outer surface of the body and outer surface of the impedance matching layer may be co-planar.

In use, the (e.g. input face of the) input may be arranged to be impacted, e.g. by a projectile, e.g. directed along the central axis so to be incident upon the input (face). (The axis of the body or volume may be defined as being parallel to (e.g. coaxial with) the direction between the (e.g. centre of the) input and the (e.g. centre of the) output.) Thus, in some embodiments, the input shockwave may be generated in the component, for example, by the (e.g. input face of the) input (e.g. the body and/or the layers of the volume) being struck or impacted (e.g. by a projectile). In some embodiments, the input shockwave may be generated externally from the component, and, e.g., be received by (e.g. be incident upon) the input of the volume.

The impedance matching layer may be formed from any suitable and desired material. In some embodiments, the impedance matching layer has a shock-impedance greater than a shock-impedance of the second material. In some embodiments, the impedance matching layer has a shock-impedance substantially equal to a shock-impedance of the body.

Preferably the impedance matching layer is a solid. Preferably the impedance matching layer comprises (e.g. is formed from, e.g. consists of) a (e.g. heavy) metal, e.g. a transition metal, e.g. a refractory metal, e.g. tantalum, platinum, steel, copper or tungsten. The impedance matching layer may be formed of the same material as the material of the projectile and/or the body. Thus, the impedance matching layer may have a shock-impedance substantially equal to a shock-impedance of the projectile.

In embodiments, the plurality of layers comprises at least one first layer and at least one second layer, wherein the at least one first layer comprises (e.g. is formed from, e.g. consists of) a third material, and the at least one second layer comprises (e.g. is formed from, e.g. consists of) the second material.

In embodiments, the third material has a higher shock-impedance than the shock-impedance of the second material.

In embodiments, the third material is the same (material) as the first material, e.g. the first layer(s) are formed from the same material as the body.

In embodiments, the plurality of layers comprises one or more (e.g. first and/or second) layers (e.g. each) having a non-uniform (e.g. variable) thickness (e.g. the shortest distance from the input face to the output face of the layer at any given point). Thus, different portions of a shock-front will spend different lengths of time propagating through the one or more layers. Since the material of the layer may alter the speed of the shockwave, a layer having a non-uniform thickness may alter the shape of the shock-front.

In embodiments, the plurality of (e.g. first and/or second) layers comprises one or more layers (e.g. each) having an input face comprising a convex portion (when viewed in the direction from the input to the output of the volume and layer). In embodiments, the (e.g. entire) input face may be convex. A layer having an input face comprising at least a convex portion may help to spherically focus the input shockwave.

In embodiments, the plurality of (e.g. first and/or second) layers comprises one or more layers (e.g. each) having an output face comprising a concave portion (when viewed in the direction from the input to the output of the volume and layer). In embodiments, the (e.g. entire) output face may be concave. A layer having an output face comprising at least a concave portion may help to spherically focus the input shockwave.

In embodiments, the at least one first layer (e.g. each of the first layers) has a non-uniform thickness.

In embodiments, the at least one first layer (e.g. each) has a greater thickness at or close to a central axis of the volume, than the thickness of the layer at or close to the (e.g. wall of the) body. In embodiments where the third material has a greater shock-impedance than the second material, the shockwave will travel slower in the first layers than in the second layers. By providing one or more first layers (e.g. each) having a greater thickness at or close to the central axis of the volume than the thickness at or close to the (e.g. wall of the) body, the portion of the shock-front at or close to the (e.g. wall of the) body travels slowly for a shorter period of time than the central portion of the shock front, which helps to spherically focus the shock-front.

In embodiments, the at least one first layer (e.g. each) has a thickness that tapers (e.g. to zero). The thickness of the at least one first layer may taper (e.g. to zero) at any suitable and desired point in the layer. In some embodiments, the at least one first layer may have a thickness that tapers (e.g. to zero) at or close to the (e.g. wall of the) body. Thus the at least one first layer may (and in embodiments does) not extend all the way to the (e.g. wall of the) body, e.g. the at least one first layer is (e.g. each) spaced from the (e.g. wall of the) body.

In embodiments, the at least one first layer (e.g. each) has a greater thickness at or close to the (e.g. wall of the) body, than the thickness of the layer at or close to a central axis of the volume. In embodiments, at least one first layer may have a thickness that tapers (e.g. to zero) at or close to a central axis of the volume. For example, the at least one first layer has a conical depression in the input face of the (e.g. each) first layer. This may help to direct the shockwave away from the (e.g. walls of the) body.

In embodiments, the at least one first layer (e.g. each) comprises one or more apertures (e.g. through the (thickness of the) layer). This may help to manipulate the shockwave as it passes through the first layer(s), e.g. by creating a low resistance path for the shockwave. For example, the (portion of the) shockwave passing through the aperture may overlap with reflections of the shockwave to increase the pressure of the shockwave.

The aperture(s) may be provided at any suitable and desired location in the first layer(s). In one embodiment, the at least one first layer (e.g. each) comprises an aperture at the centre of the first layer, e.g. at (e.g. centred on) the central axis of the volume. When the volume comprises a plurality of first layers and two or more of the first layers comprise an aperture, the apertures may be aligned with each other, e.g. along the central axis of the volume. Providing aperture(s) at the centre of the first layer(s) may help to reduce (e.g. prevent) reflections (at the axis) of the shockwave propagating away from the output.

In embodiments, the plurality of layers alternate between the first layers and the second layers, e.g. (each of one or more of) the first layer(s) is adjacent (sandwiched between) two second layers and/or (each of one or more of) the second layer(s) is adjacent (sandwiched between) two first layers.

In the embodiments in which the plurality of layers comprises a plurality of first layers and/or a plurality of second layers, each of the first layers may comprise (e.g. consist of) the same (e.g. third) material and/or each of the second layers may comprise (e.g. consist of) the same (e.g. second) material. However, in some embodiments, one or more of the plurality of first layers may comprise (e.g. consist of) a material that is different from the third material and/or one or more of the plurality of second layers may comprise (e.g. consist of) a material that is different from the second material.

In embodiments, one or more of the first layers and/or the second layers comprise compound layers, i.e. the layers (e.g. each) comprise a plurality of sub-layers. The sub-layers may be formed of different materials (e.g. materials that are different from the other sub-layers and/or materials that are different from the second material and/or third material).

In embodiments in which the plurality of layers comprises at least one first layer and at least one second layer, preferably one or more (e.g. all) of the at least one second layer (e.g. each) has a maximum thickness that is greater than the maximum thickness of (e.g. each of) one or more (e.g. all) of the at least one first layer.

In embodiments in which the plurality of layers comprises a plurality of first layers and/or a plurality of second layers, each of the plurality of first layers may have the same maximum thickness and/or each of the plurality of second layers may have the same maximum thickness, preferably with the plurality of second layers (e.g. each) having a maximum thickness greater than the maximum thickness of (e.g. each of) the plurality of first layers.

In embodiments, the maximum thicknesses of the plurality of first layers differs between the first layers. In embodiments, the maximum thicknesses of the plurality of second layers differs between the second layers, i.e. the maximum thicknesses of the respective layers are different from each other.

In embodiments, the maximum thicknesses of the plurality of first layers decrease (e.g. progressively) from the input to the output. In embodiments, the maximum thicknesses of the plurality of second layers decrease (e.g. progressively) from the input to the output.

In embodiments, the average thicknesses (e.g. the average thickness of each layer across its width) of the plurality of first layers decrease (e.g. progressively) from the input to the output. In embodiments, the average thicknesses (e.g. the average thickness of each layer across its width) of the plurality of second layers decrease (e.g. progressively) from the input to the output.

In embodiments, one or more (e.g. all) of the layers extends across the (width of the) volume (i.e. in a direction perpendicular to the direction from the input to the output). For example, one or more (e.g. all) of the first layer(s) and/or one or more (e.g. all) of the second layer(s) may extend across the volume.

The various materials discussed herein (including the first and second materials) may comprise any suitable and desired materials. In embodiments, the first material comprises (e.g. is formed from, e.g. consists of) a solid. In embodiments, the first material comprises (e.g. is formed from, e.g. consists of) a (e.g. heavy) metal, e.g. a transition metal, e.g. a refractory metal, e.g. tantalum, platinum, steel, copper or tungsten. The first material may be formed of the same material as the material of the projectile.

In embodiments the second material comprises (e.g. consists of) a solid. In embodiments, the second material comprises (e.g. consists of) a polymer, e.g. a thermopolymer, e.g. polymethyl methacrylate (PMMA). In embodiments, the second material comprises (e.g. consists of) a liquid, e.g. water, ethanol or oil. In embodiments in which the plurality of layers comprises a plurality of second layers, one or more of the plurality of second layers may comprise (e.g. consists of) a gas or a vacuum.

The body may comprise (e.g. (internal) walls having) any suitable and desired shape to define the volume.

In embodiments, the body is shaped such that a cross sectional area of the input (e.g. in a plane perpendicular to the central axis of the body and/or volume, wherein the central axis extends between the (e.g. centre of the) input and the (e.g. centre of the) output) is greater than a cross sectional area of the output.

In embodiments, the body (and thus the volume) is shaped such that the input has a cross sectional area that is greater than the (e.g. corresponding) cross sectional area of the output. The cross sectional area of the input and/or the output may be defined in a plane substantially perpendicular to a direction between the input and the output (e.g. to the central axis of the body and/or volume).

Thus, the cross sectional area of the input may be substantially parallel to the cross sectional area of the output, e.g. the (plane of the) input aperture is substantially parallel to the (plane of the) output aperture.

The direction between the input and the output may be substantially parallel to the direction in which, in embodiments of the invention, the input shockwave is arranged to be propagated to be incident upon the component.

In embodiments, the body (and thus the volume) may be shaped such that the cross sectional area of the volume (in a plane substantially perpendicular to the direction between the input and the output) may decrease linearly or non-linearly. In embodiments, the cross sectional area of the volume may initially increase when moving from the input towards the output, and then decrease. In embodiments, the cross sectional area of the output may be greater than the cross sectional area of the input or the cross sectional area of the volume between the input and the output (e.g. the volume may have a flared output). Thus, for example, the cross sectional area of the volume may initially decrease when moving from the input towards the output, and then increase.

In embodiments, the (e.g. a section of the) volume comprises a frustum, e.g. the body is shaped to define a frustum-shaped volume. Thus, preferably a cross section of the volume (e.g. in a plane parallel to the direction between the input and the output) comprises straight sides (walls) and, e.g., the cross-section is symmetrical (in that plane).

The frustum may comprise any suitable and desired type of frustum. In embodiments, the volume comprises a conic frustum. Thus, preferably the volume is rotationally symmetric about the central axis of the volume.

In embodiments, the (cross section and/or walls of the) volume comprises two or more sections (e.g. sub-volumes) that are at different respective angles to the axis of the volume (e.g. the axis about which the volume is rotationally symmetric, e.g. parallel to the direction between the input and the output). Thus, for example, the volume may comprise two or more frustums (e.g. with the output of one frustum coinciding with the input of the other frustum, for each pair of successive frustums), wherein the two or more frustums have side walls having different respective angles to the axis of the volume. Providing different angles for the volume sections may help to manipulate the input shockwave in a particular manner, e.g. to accelerate the input shockwave from the input to the output.

In embodiments in which the volume has three or more frustum sections, each section may be at a different angle to each of the other sections; however, two or more of the sections may be at the same angle, with one or more intermediate sections of the volume at a different angle.

In embodiments, more complex volume shapes may be used. In embodiments, the volume is approximately bowl shaped (e.g. the wall is continuously curved). In embodiments, the volume may be approximately bowl shaped, but proximal to the output, the wall of the volume may transition (e.g. curve) back towards the input such that a cross section taken through the volume (e.g. in a plane containing the central axis of the volume) forms an approximate curved “W” shape (e.g. the wall of each half of the volume may have a logarithmic spiral shape).

When viewed from a further aspect, the invention provides a component for manipulating an input shockwave, wherein the component comprises:
a first face for receiving the input shockwave incident upon the component;
a second face for outputting the manipulated shockwave from the component; and
a plurality of layers between the first (component input) face and the second (component output) face;
wherein the plurality of layers comprises one or more layers having a non-uniform thickness and/or one or more layers having a layer input face and/or a layer output face comprising a non-planar (e.g. curved) portion.

It will be appreciated that this aspect may (and preferably does) include one or more (e.g. all) of the preferred and optional features disclosed herein, e.g. relating to other aspects and embodiments of the invention, as applicable.

In embodiments, the volume is partially filled with the plurality of layers, i.e. the plurality of layers does not (fully) fill the volume. Thus, in embodiments, the volume comprises a spacing between the input of the volume and (an input surface of) the plurality of layers (this spacing may also be seen as a layer that is filled with gas or a vacuum). Depending on the size and/or shape of an incident projectile, which may be used to generate the input shockwave, providing a gap in the volume between the input (e.g. aperture) and the plurality of layers may allow the projectile to impact the (e.g. walls of the volume of the) body of the component directly, e.g. before impacting the plurality of layers. This may generate a lateral shockwave inside the projectile that may then be transferred into the volume.

The lateral shockwave inside the projectile may help to provide transverse focusing within the projectile. This in turn has the effect that the shockwave that is transferred into the volume is focused more towards the central axis of the volume.

In embodiments, the volume comprises a first sub-volume and a second sub-volume (each) arranged between the input of the volume and the output of the volume. Preferably the first sub-volume comprises an input and an output. Preferably the second sub-volume comprises an input and an output. Preferably the output of the first sub-volume is coupled to the input of the second sub-volume. Thus. the volume may be shaped to have two (or more) sub-volumes, with the first sub-volume arranged proximal to the input of the volume and the second sub-volume arranged proximal to the output of the volume.

In embodiments, the body is shaped such that a cross sectional area of the output of the first sub-volume may be different (e.g. a different size) to the cross sectional area of the input of the second sub-volume. For example, the cross sectional area of the output of the first sub-volume may be greater than the cross sectional area of the input of the second sub-volume.

In preferred embodiments, the body is shaped such that a cross sectional area of the output of the first sub-volume is less than a cross sectional area of the input of the second sub-volume. Shaping the volume in this way to provide multiple sub-volumes helps to at least partially recapture the manipulated shockwave that is output from one (e.g. the first) sub-volume by the input of the subsequent (e.g. the second) sub-volume. This may enable the shockwave to then be further manipulated by (e.g. focused in) the subsequent sub-volume. This may help to reduce the energy of the input shockwave that is lost into the body of the component and thus help to increase the energy that is transmitted in the manipulated shockwave that is output from the volume.

Preferably the input of the first sub-volume has a cross sectional area that is greater than a cross sectional area of the output of the first sub-volume. Preferably the input of the second sub-volume has a cross sectional area that is greater than a cross sectional area of the output of the second sub-volume. In this way, both of the sub-volumes have a cross-sectional area that decreases from the respective input to the output, with the cross-sectional area increasing from the output of the first sub-volume to the input of the second sub-volume.

In embodiments, the volume comprises a plurality of sub-volumes, wherein each sub-volume comprises an input and an output, wherein the output of each sub-volume (apart from the output of the sub-volume proximal to the output of the volume) is coupled to the input of the subsequent sub-volume (in a direction from the input to the output of the volume), wherein the body is shaped such that a cross sectional area of the output of the each sub-volume (apart from the output of the sub-volume proximal to the output of the volume) is less than a cross sectional area of the input of the subsequent sub-volume.

Thus, preferably the volume has multiple linked sub-volumes from the input of the volume to the output of the volume, along the direction between the input of the volume to the output of the volume. Preferably the output of each (e.g. the first) sub-volume is completely overlapping with (falls within) the input of the subsequent (e.g. the second) sub-volume. Thus, in embodiments, the wall(s) of the volume comprise portions that project at least partially inwards (towards the central axis of the volume, e.g. as well as projecting towards the output) to define the (inputs and outputs of the) sub-volumes.

The features described herein in relation to the volume as a whole apply, where applicable, to one or more (e.g. each) of the sub-volumes. Thus, for example, one or more (e.g. each) of the sub-volumes comprises a plurality of layers between the input and the output of the (respective) sub-volume. Preferably the plurality of layers (in one or more (e.g. each) of the sub-volumes) comprises one or more layers comprising a second material (that is different from the first material). Preferably the plurality of layers (in one or more (e.g. each) of the sub-volumes) comprises one or more layers having a non-uniform thickness; and/or one or more layers having an input face and/or an output face comprising a non-planar (e.g. curved, e.g. convex) portion.

In embodiments, one or more (e.g. each) of the sub-volumes comprises a (e.g. first) layer that extends across the input and/or output of the (respective) sub-volume. In embodiments, one or more (e.g. each) of the sub-volumes comprises a second layer, e.g. adjacent the first layer. In embodiments, the volume may comprise a (e.g. first) layer between (e.g. each of) the adjacent sub-volumes. Separating the sub-volumes with a (e.g. first) layer may help to couple the shockwave between the sub-volumes.

In embodiments, the component comprises a gap between one or more (e.g. all) of the plurality of layers and the body of the component, i.e. between one or more (e.g. all) of the plurality of layers and the wall(s) of the body that define the volume. Thus one or more (e.g. all) of the plurality of layers may be spaced from the body of the component, i.e. from the wall(s) of the volume.

The gap may be filled (e.g. comprise or consist of) a vacuum. In embodiments, the gap comprises a buffer layer (e.g. comprising (e.g. consisting of) a fourth material) adjacent the walls of the volume. Thus the (walls of the) volume may be lined with the buffer layer. The fourth material may be located between one or more (e.g. all) of the plurality of layers and the body of the component.

The fourth material may comprise any suitable and desired material. In embodiments, the fourth material is the same as the second material. In embodiments, the fourth material comprises (e.g. is formed from, e.g. consists of) a low density material, such as PMMA or epoxy resin.

The gap and/or the buffer layer may help to reflect shockwaves from the volume wall, reducing coupling of the shockwave into the body of the component and, e.g., instead focusing the shockwave towards the output of the volume.

The (e.g. body of the) component may have any suitable and desired dimensions, e.g. to be determined by the specific application of the component. In one embodiment the (e.g. volume of the) body has a thickness, diameter and/or maximum dimension between 0.1 mm and 100 mm, e.g. between 1 mm and 50 mm, e.g. between 2 mm and 10 mm, e.g. approximately 3 mm, 5 mm or 8 mm.

When viewed from a further aspect, the invention provides a method of manipulating a shockwave, the method comprising generating at least one shockwave to be incident upon a component according to any one of the aspects or embodiments described herein.

It will be appreciated that this aspect may (and preferably does) include one or more (e.g. all) of the preferred and optional features disclosed herein, e.g. relating to other aspects and embodiments of the invention, as applicable.

For example, preferably the shockwave is arranged to be incident upon (e.g. generated at) the input of the component. Preferably the shockwave is arranged to propagate along a direction parallel to the direction between the input and the output of the component. Thus, preferably the shockwave is arranged to be incident upon (e.g. generated at) the input of the component in a plane parallel to a plane of the input of the component (e.g. in the plane of the input).

When viewed from a further aspect, the invention provides a system for producing a localised concentration of energy comprising:
a component according to any one of the aspects or embodiments described herein; and
a mechanism for generating at least one shockwave propagating through the component.

It will be appreciated that this aspect may (and preferably does) include one or more (e.g. all) of the preferred and optional features disclosed herein, e.g. relating to other aspects and embodiments of the invention, as applicable.

In embodiments, the mechanism comprises:
a driving mechanism configured to drive a projectile into the component to generate a shockwave at the input (e.g. input (or input face) of the component or volume).

The projectile preferably comprises an impacting surface configured to impact the (e.g. input (or input face) of the) component.

In some embodiments, the impacting surface of the projectile comprises a substantially flat (e.g. planar) portion. Such projectiles may, for example, be used with a component having an input face or layer comprising a concave portion. This may help to generate an input shockwave having a curved shock-front in the focusing portion.

In some embodiments, the impacting surface of the projectile comprises a non-planar, e.g. curved (e.g. concave or convex (when viewed externally from the projectile)), portion. Such projectiles may be used with a component having an input face or layer comprising a substantially flat portion and may be configured to strike a (e.g. volume input of a) component to generate a shockwave having a curved shock-front in the (e.g. volume of the) component.

This is considered to be novel and inventive in its own right, and thus when viewed from a further aspect, the invention provides a system for producing a localised concentration of energy comprising:
a component for manipulating an input shockwave;
a driving mechanism configured to drive a projectile into the component to generate a shockwave in the component; and
a projectile having an impacting surface comprising a non-planar portion configured to impact the component.

It will be appreciated that this aspect may (and preferably does) include one or more (e.g. all) of the preferred and optional features disclosed herein, e.g. relating to other aspects and embodiments of the invention, as applicable.

Preferably the projectile comprises (e.g. is formed from, e.g. consists of) a solid. Preferably the projectile comprises (e.g. is formed from, e.g. consists of) a high shock-impedance material. In embodiments the projectile comprises (e.g. is formed from, e.g. consists of) a (e.g. heavy) metal, e.g. a transition metal, e.g. a refractory metal, e.g. tantalum. The projectile may comprise (e.g. be formed from, e.g. consists of) tungsten, steel, copper or other (e.g. heavy) metals. The projectile may comprise (e.g. be formed from, e.g. consist of) the first material. Thus, the projectile may be formed from the same material as the body and/or the impedance matching layer of the component.

In embodiments the projectile comprises (e.g. is formed from, e.g. consists of) the second material. Thus, in embodiments, the projectile comprises (e.g. is formed from, e.g. consists of) a lower shock-impedance material, e.g. a low density metal, e.g. aluminium, or a lower density material, e.g. PMMA.

In embodiments, the mechanism for generating a shockwave comprises an explosively driven mechanism, such as a gas gun, configured to drive the projectile into the component.

In embodiments, the mechanism for generating a shockwave comprises an electromagnetic mechanism, such as a pulsed power machine magnetically driven plate flyer, configured to drive the projectile into the component.

In embodiments, the (e.g. electromagnetic) mechanism for generating a shockwave comprises a direct drive mechanism configured to generate a Lorentz force in an electrode adjacent the component. In such embodiments, the Lorentz force generates a shockwave in the electrode, which is transmitted to the input of the component.

In embodiments, the mechanism for generating a shockwave comprises a laser drive mechanism. The mechanism may comprise an ablator layer adjacent the input of the component and one or more lasers configured to ablate the ablator layer creating a shockwave in the component. In embodiments, the lasers are incident directly on the ablator layer. In embodiments, the lasers are incident on a hohlraum surface, creating X-rays that bathe the ablator material causing it to ablate.

In embodiments, the system further comprises a target configured to contain matter to be compressed, e.g. in a recess of the target, which may be arranged adjacent the output of the component. Preferably, the component and the target are configured such that the manipulated shockwave is arranged to be output from the component so to be incident upon the target, e.g. to compress the matter in the target.

In embodiments, the matter to be compressed comprises a fuel, e.g. a fusionable fuel (e.g. hydrogen, deuterium and/or tritium). When fuel is present in the volume and an input shockwave is manipulated by the focusing element to produce a localised energy concentration at the volume, this may cause the fuel in the volume to collapse, creating high pressures and temperatures within the fuel, e.g. sufficient for initiating fusion.

Furthermore, it will be appreciated that one or more (e.g. all) of the embodiments described herein may be combined with each other (in any appropriate combination), as applicable, to provide further embodiments.

It will be understood that where used herein, the term “shock-impedance” is intended to mean “the pressure which must be applied to a medium in order to impart a unit particle velocity to some of the medium” (Henderson, ‘On the refraction of shock waves’, Journal of Fluid Mechanics, Volume 198, January 1989, pages 365-386). This is equal to the product of the shock speed and the density of the un-shocked material.

It will be understood that the input shockwave may be formed outside of the volume, and propagate into the input of the volume, but may additionally or alternatively be generated in the component, for example by the component being struck (e.g. by a projectile). Both of these examples are covered by the wording “input shockwave”.

### BRIEF DESCRIPTION OF DRAWINGS

Certain embodiments of the invention will now be described, by way of example only, with reference to the accompanying drawings, in which:

FIG. 1 shows a component in accordance with one embodiment of the invention;

FIG. 2 shows a system incorporating the component of FIG. 1;

FIG. 3 shows a component in accordance with another embodiment of the invention;

FIG. 4 shows a component in accordance with another embodiment of the invention;

FIG. 5 shows a variant of the embodiment of FIG. 4;

FIG. 6 shows a variant of the system of FIG. 2;

FIG. 7 shows a variant of the embodiment of FIG. 4, configured for use in the system of FIG. 6;

FIG. 8 shows a variant of the embodiment of FIG. 7;

FIG. 9 shows a variant of the embodiment of FIG. 8;

FIG. 10 shows a variant of the embodiment of FIG. 8;

FIG. 11 shows a variant of the embodiment of FIG. 8;

FIG. 12 shows a shows a variant of the embodiment of FIG. 4; and

FIG. 13 shows a shows a variant of the embodiment of FIG. 4.

### DETAILED DESCRIPTION

Components for producing localised energy concentrations by manipulating an input shockwave will now be described.

While the embodiments are shown in certain orientations, it will be appreciated that, in use, the components and systems may operate in any suitable and desired orientation.

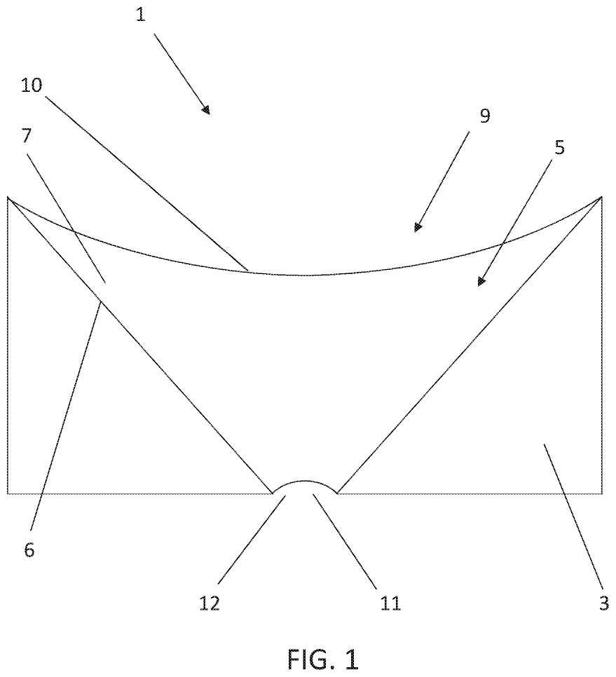

FIG. 1 shows a cross section through a component 1 in accordance with one embodiment of the invention.

The illustrated cross-section is taken in a plane containing a central longitudinal axis of the component 1 that extends between the input and the output of the component 1. In embodiments, the component 1 is rotationally symmetrical about the central axis.

The component 1 comprises a body 3 that defines a hollow frustum shaped volume 5. The volume 5 is defined by walls 6. The body 3 is formed of a material having a high shock-impedance. In an exemplary embodiment, the body 3 is formed of tantalum. The body 3 may be formed of other materials, for example other heavy metals, e.g. tungsten, steel, copper or platinum.

The volume 5 contains a material 7 having a low shock-impedance. The volume fill material 7 has a lower shock-impedance than that of the body 3. In an exemplary embodiment, the volume fill material 7 is polymethyl methacrylate (PMMA).

The volume 5 has an input aperture 9 that is configured to receive a shockwave, and an output aperture 11 that is configured to output the shockwave after the shockwave has propagated through the component 1. The cross sectional area of the input aperture 9 is greater than that of the output aperture 11.

FIG. 1 shows a cross section through the component, in a plane containing a longitudinal axis of the component 1, the longitudinal axis extending perpendicularly between the plane of the input aperture 9 and the plane of the output aperture 11. In the illustrated embodiment, the component 1 is rotationally symmetrical about the longitudinal axis. It will therefore be understood that the volume 5 of the component 1 is shaped as a conic frustum with an input radius greater than the output radius.

The component 1 has an input face 10 that is proximal to the input 9 of the volume 5, and an output face 12 that is proximal to the output 11 of the volume 5.

The input face 10 is at least partially formed by the volume fill material 7. The portion of the input face 10 that is formed by the volume fill material is concave, such that the centre of the input face 10 is recessed with respect to the perimeter of the input face 10.

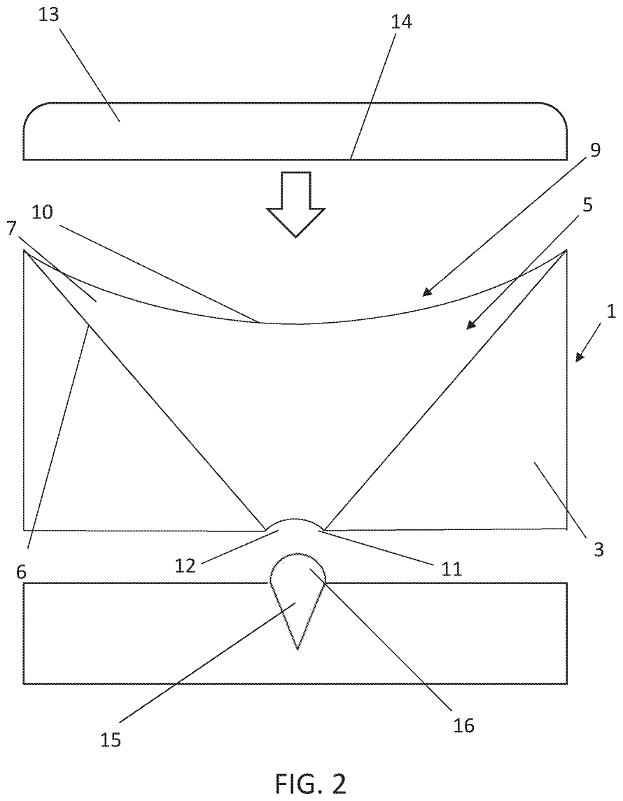

Operation of the component 1 will now be explained with reference to FIG. 2. FIG. 2 shows a system in accordance with an embodiment of the invention, incorporating the component of FIG. 1.

The input 9 is configured to receive a shockwave. In the embodiment shown in FIG. 2, this shockwave is generated by striking the input face 10 of the component 1 with a disc shaped projectile 13 having a flat impacting surface 14. In the illustrated embodiment, the projectile 13 is at least partially formed of tantalum, but may be formed of other heavy metals such as tungsten, platinum, steel, or copper.

Since the input face 10 is concave, the projectile 13 strikes the perimeter of the input face 10 before it strikes the centre. This acts to give the resultant shock in the component 1 a curved front, owing to the differences in shock and particle velocities in the different stages of the process.

The projectile 13 is travelling at speed “X”, and drives a shock in the volume fill material 7 at each position it impacts with a shock velocity of “Y”. Y is greater than X, and as such, owing to the curvature of the input face 10, the shock is travelling faster at the edge of the component than the projectile 13 is travelling on the central axis, and thus will be further into the component 1 by the time of projectile impact on the central axis. This helps to give the shock a degree of spherical focusing.

The shockwave in the component 1 is then focused by the volume 5 onto a target 15, creating a localised concentration of energy at the location of the target 15.

Pressures are increased in the component 1 through shockwave reflection and superposition within the volume 5, as will now be described.

On input into the volume 5, the input shock reflects from the walls 6 as an irregular shock reflection (Mach reflection), that propagates in from the walls 6, eventually overlapping on the central axis of the volume 5. The shockwave eventually reaches the output 11 of the volume 5 and emerges from the component 1 with a higher pressure than that of the original input shockwave.

The target 15 is a conic target with a spherical cap 16. Modelling of idealised conic targets with a spherical cap, suggests that these targets can greatly exceed the performance of standard conic targets if the shock driving the target is also spherical.

For illustrative purposes, the target 15 is shown as separate to the component 1 in FIG. 2, but it will be understood that the spherical cap of the target 15 may be in contact with the output face 12 of the volume 5, or the output face 12 of the volume 5 may comprise the spherical cap of the target 15. As such, the target 15 may also be defined by the body 3.

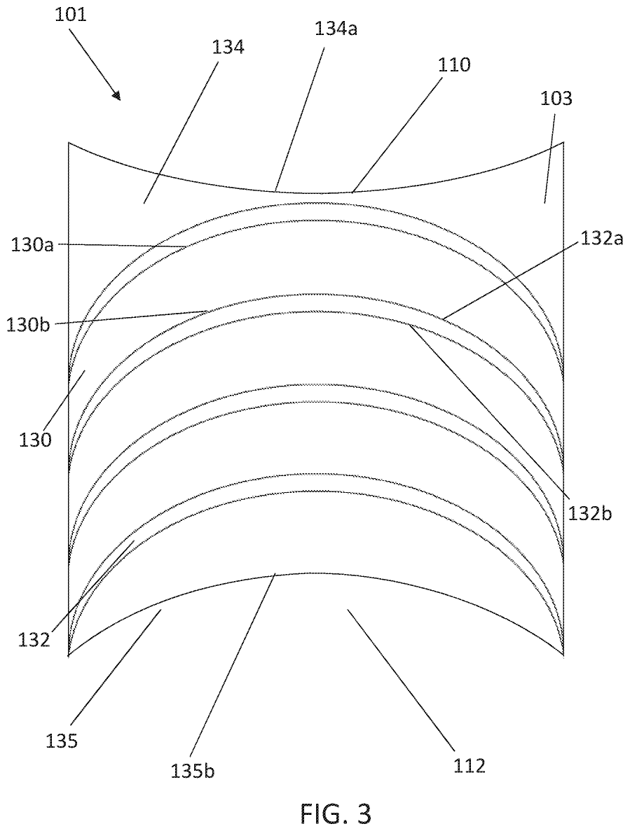

FIG. 3 Shows a Component 101 According to Another Embodiment of the Invention.

The component 101 comprises a body 103 formed of a series of layers. The layers comprise low shock-impedance layers 130 formed of a low shock-impedance material such as PMMA or epoxy resin, and high shock-impedance layers 132 formed of a high shock-impedance material such as tantalum, platinum, tungsten, steel, copper, or other (e.g. heavy) metals. As a minimum requirement, the high shock-impedance layers 132 is formed of a material having a higher shock-impedance than the material forming the low shock-impedance layers. In preferred embodiments, the ratio of the shock-impedance of the high shock-impedance layers to the shock-impedance of the low shock-impedance layers is high, such that there is a large shock-impedance difference at the boundary between layers.

The layers alternate from low shock-impedance layers 130 to high shock-impedance layers 132 from one layer to the next. In the illustrated embodiment, an input layer 134 that forms the input face 110 of the component 101 is a low shock-impedance layer 130. An input face 110 formed from a high shock-impedance layer 132 may result in a larger portion of the shockwave being reflected by the input face 110, and hence not transmitted into the component 101. In some embodiments, an input face 110 formed from a high shock-impedance layer 132 may help to better couple the shock into the component 101, since a high shock-impedance layer may have a more similar shock-impedance to that of a projectile striking the component.

In the illustrated embodiment, the low shock-impedance layers 130 are each of approximately equal maximum thickness and the high shock-impedance layers 132 are each of approximately equal maximum thickness. In embodiments, however, the low shock-impedance layers may have maximum thicknesses that decrease progressively from the input face 110 to the output face 112. In embodiments, the maximum thicknesses of the high shock-impedance layers 132 may also decrease progressively from the input face 110 to the output face 112.

Each of the high shock-impedance layers 132 has a convex input face 132a and a concave output face 132b. As such, with the exception of the input layer 134 and the output layer 135, each of the low shock-impedance layers 130 also has a convex input face 130a and a concave output face 130b. In the illustrated embodiment, the input face 134a of the input layer 134 is concave, as with the embodiment of FIG. 1, and the output face 135b of the output layer 135 is also concave.

The layers are arranged such that shockwaves generated at the input face 110 of the component 101 of the layer stack reverberate within the stack of layers 134, 130, 132, 135, as a result of reflections from the boundaries between low and high shock-impedance layers 130, 132, leading to regions of constructive and destructive interference as shock waves pass over one another. When a shock passes from a low shock-impedance layer 134, 130 into a high shock-impedance layer 132, a portion of the shock is transmitted into the high shock-impedance layer 132 whilst a portion is reflected back into the low shock-impedance layer 134, 130.

The portion in the low shock-impedance layer 134, 130 speeds up since it is now travelling through pre-shocked material. The shock portion then reflects from the boundary at the input of the low shock-impedance layer, and since it has been sped up, the reflected portion eventually catches up with the portion of the shock that was initially transmitted into the high shock-impedance layer 132.

Through the arrangement of the low and high shock-impedance layers 134, 130, 132, 135, the component 101 can be arranged such that a plurality of shock portions superimpose at the output face 112 of the component 101, leading to a short-lived high shock pressure state that can be passed into a target adjacent to the component output 112.

In the illustrated embodiment, all of the high shock-impedance layers 132 are formed from the same material, and all of the low shock-impedance layers 134, 130, 135 are formed from the same material. In embodiments, different low shock-impedance materials may be used for the different low shock-impedance layers 134, 130, 135, and different high shock-impedance materials may be used for the different high shock-impedance layers 132.

The high shock-impedance layers 132 each have a variable thickness such that they are thicker on the central axis than at the edge. Similarly to the function of the concave input face described above, this acts to curve the shock because the shock speed in the high shock-impedance layers is slower than in the low shock-impedance layers. Therefore, since the portion of the shock-front on the central axis has to travel through more high shock-impedance material than the portion of the shock-front at the edge, the portion of the shock-front at the edge overtakes the central portion of the shock-front, resulting in spherical focusing.

The high shock-impedance layers 132 are curved because the shockwave becomes increasingly spherical as it propagates through the component 1. As such, for the shocks to effectively reflect from the boundaries between the layers, the boundaries between the layers are similarly curved, such that the boundary at any given position is approximately parallel to the shock-front at that position. Similarly, for the shocks to effectively propagate from the output (without at least partially undoing the spherical focusing) the output face is curved in line with the curvature of the layers, such that the output face at any given position is approximately parallel to the shock-front at that position.

In preferred embodiments, the curve on the input face 132a of each high shock-impedance layer is not more than the curvature of the output face 132b of the previous high shock-impedance layer 132. If this is not the case, the distance between the two high shock-impedance layers will be greater at the edges of the layers than on the central axis. Therefore, the reverberations will take longer at the edges and hence the shock front at the central axis will ‘catch up’, reducing the degree of spherical focusing.

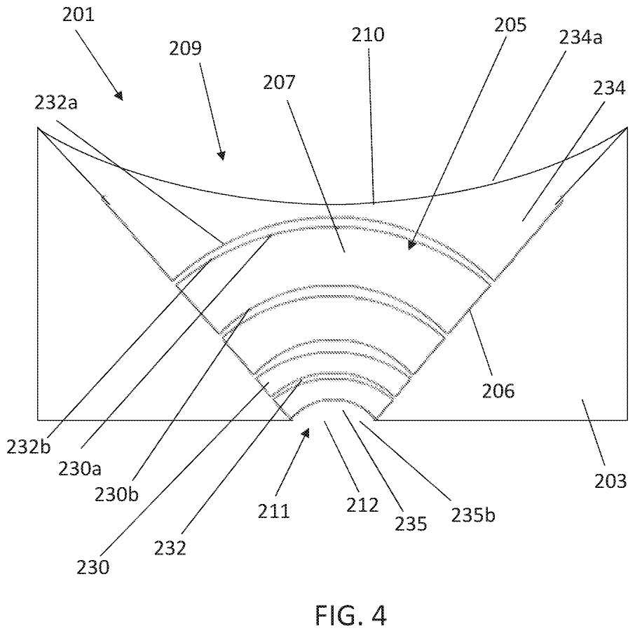

FIG. 4 shows a component 201 in accordance with an embodiment of the invention, which combines the features of the component 1 shown in FIG. 1 and the component 101 shown in FIG. 3.

The component 201 comprises a body 203 that defines a hollow conic frustum shaped volume 205. The body 203 is formed of a material having a high shock-impedance. The volume 205 contains a material 207 having a low shock-impedance. The volume fill material 207 has a lower shock-impedance than that of the body 203. Within the volume 205, a plurality of high shock-impedance layers 232 are provided.

The volume 205 has an input 209 that is configured to receive a shockwave, and an output 211 that is configured to output the shockwave after the shockwave has propagated through the component 201. The cross sectional area of the input 209 is greater than that of the output 211.

FIG. 4 shows a vertical cross section, but in the illustrated embodiment, the component 201 is rotationally symmetrical. It will therefore be understood that the volume 205 of the component 201 is shaped as a conic frustum with an input radius greater than the output radius. The component 201 itself has an input face 210 that is proximal to the input 209 of the volume 205, and an output face 212 that is proximal to the output 211 of the volume 205.

The volume 205 is filled with low shock-impedance layers 230 that are formed from the low shock-impedance volume fill material 207 (PMMA in the illustrated embodiment), and high shock-impedance layers 232 formed from the high shock-impedance material (tantalum in the illustrated embodiment). As a minimum requirement, the high shock-impedance layers 232 is formed of a material having a higher shock-impedance than the material forming the low shock-impedance layers 230.

The parallel layers alternate from low shock-impedance layers 230 to high shock-impedance layers 232 from one layer to the next. In the illustrated embodiment, an input layer 234 that forms the input face 210 of the component 201 is a low shock-impedance layer. This is because an input face 210 formed from a high shock-impedance layer 232 may result in a larger portion of the shockwave being reflected by the input face 210, and hence not transmitted into the component 201, although the alternative is envisaged.

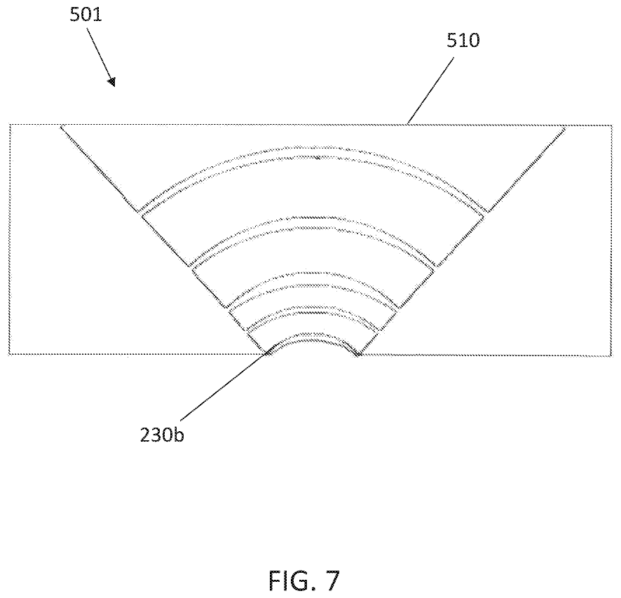

An output layer 235 forms the output face 212 of the component 201. In the embodiment of FIG. 4, the output layer 235 is a low shock-impedance layer 230a; however, the alternative is envisaged. See for example, the embodiment of FIG. 7, in which the output layer is a high shock-impedance layer 230b.

The integration of the focusing shape of the frustum shaped volume 205 with the plurality of layers 234, 230, 232, 235 leads to a component design that has been shown to be capable of greatly increasing shock pressures on output, relative to either of the features individually.

Shock reflections from the walls of the volume 205 interact with axial shock reflections from the high shock-impedance layers 232, creating regions of locally high thermodynamic pressure. These high-pressure regions expand and interact with further shock reflections downstream in the component 201, creating regions with yet-higher shock pressure, that eventually pass through to the output 211 of the volume 205.

When a shock passes from a low shock-impedance layer 234, 230 into a high shock-impedance layer 232, a portion of the shock is transmitted into the high shock-impedance layer 232 whilst a portion is reflected back into the low shock-impedance layer 234, 230. The portion in the low shock-impedance layer 234, 230 speeds up since it is now travelling through pre-shocked material, the shock portion then reflects from the boundary at the input of the low shock-impedance layer 234, 230, and since it has been sped up, the reflected portion eventually catches up with the portion of the shock that was initially transmitted into the high shock-impedance layer 232. The shockwave is also tangentially focused by the walls 206.

Through configuration of the layer materials, shapes and thicknesses, as well as the shape of the volume 205, it is possible to control the pressure of the shock at the output 211, as well as the uniformity of the shock state and shape.

In addition to generating the conditions for local shock superposition and constructive interference, the layers 234, 230, 232, 235 also act to effectively slow the shock transit time through the component 201. This allows energy from more of the projectile 13 to be harvested and combined into a single shock state upon emergence from the component 201.

Further, as explained above in reference to FIG. 1, the concave input face 210 generates a shock in the component 201 having a degree of spherical focusing. Since the input face 210 is concave, the projectile 13 strikes the perimeter of the input face 210 before it strikes the centre. This acts to give the resultant shock in the component 201 a curved front due to the differences in shock and particle velocities in the different stages of the process.

When used in a system as shown in FIG. 2 with the component 201 shown in FIG. 4, the projectile 13 is travelling at speed X, and drives a shock in the volume fill material 7 at each position it impacts with a shock velocity of Y. Y is greater than X, and as such, owing to the curvature of the input face 210, the shock is travelling faster at the edge of the component than the projectile 13 is travelling on the central axis, and thus will be further into the component 201 by the time of projectile impact on the central axis.

As the shock propagates through the component 201, it is further spherically focused by each high shock-impedance layer 232. Each of the high shock-impedance layers 232 has a convex input face 232a and a concave output face 232b. As such, with the exception of the input layer 234, each of the low shock-impedance layers 230 also has a convex input face 230a and a concave output face 230b. In the illustrated embodiment, the input face 234a of the input layer 234 is concave in line with the embodiment of FIG. 1.

The high shock-impedance layers 232 each have a variable thickness such that they are thicker on the central axis than on the edge. Similarly to the function of the concave input face described above, this acts to curve the shock because the shock speed in the high shock-impedance layers is slower than in the low shock-impedance layers. Therefore, since the portion of the shock-front on the central axis has to travel through more high shock-impedance material than the portion of the shock-front at the edge, the portion of the shock-front at the edge overtakes the central portion of the shock-front, resulting in spherical focusing.

The high shock-impedance layers 232 are curved because the shockwave becomes increasingly spherical as it propagates through the component 201. As such, for the shocks to effectively reflect from the boundaries between the layers, the boundaries between the layers must be similarly curved such that the boundary at any given position is approximately parallel to the shock-front at that position.

In preferred embodiments, the curve on the input face 232a of each high shock-impedance layer is not more than the curvature of the output face 232b of the previous high shock-impedance layer 232. If this is not the case, the distance between the two high shock-impedance layers will be greater at the edges of the layers than on the central axis. Therefore, the reverberations will take longer at the edges and hence the shock-front at the central axis will ‘catch up’, reducing the degree of spherical focusing.

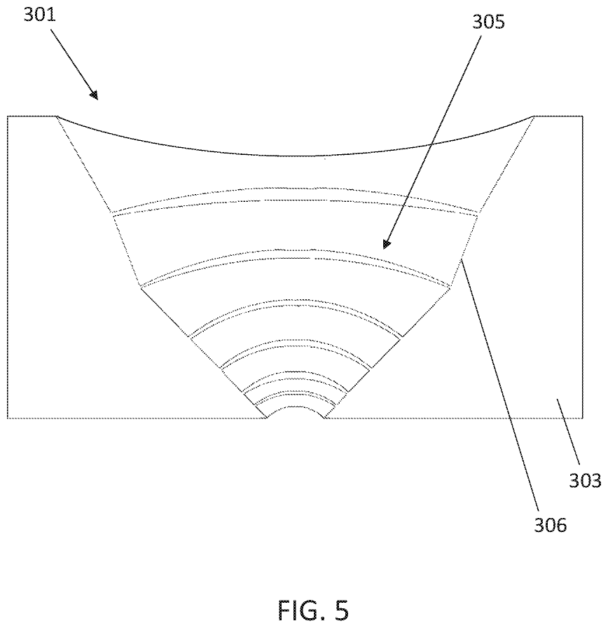

FIG. 5 shows a variant of the component shown in FIG. 4, in accordance with an embodiment of the invention.

The component 301 shown in FIG. 5 functions in substantially the same way as described above in relation to FIG. 4, but the volume body 303 is shaped such that the volume 305 has a plurality of sections (e.g. sub-volumes) that are at different respective angles to the axis of the volume. In the illustrated embodiment, the volume 305 comprises three frustums having side walls with different respective angles to the axis of the volume 305. The output of one frustum coincides with the input of the next frustum, for each pair of successive frustums.

The angle of the wall 306 varies through the volume 305 in order to account for the fact that the shock flow direction is changing as the shockwave propagates through the volume 305. By varying the wall angle accordingly, the shock reflection from the wall 306 may be improved.

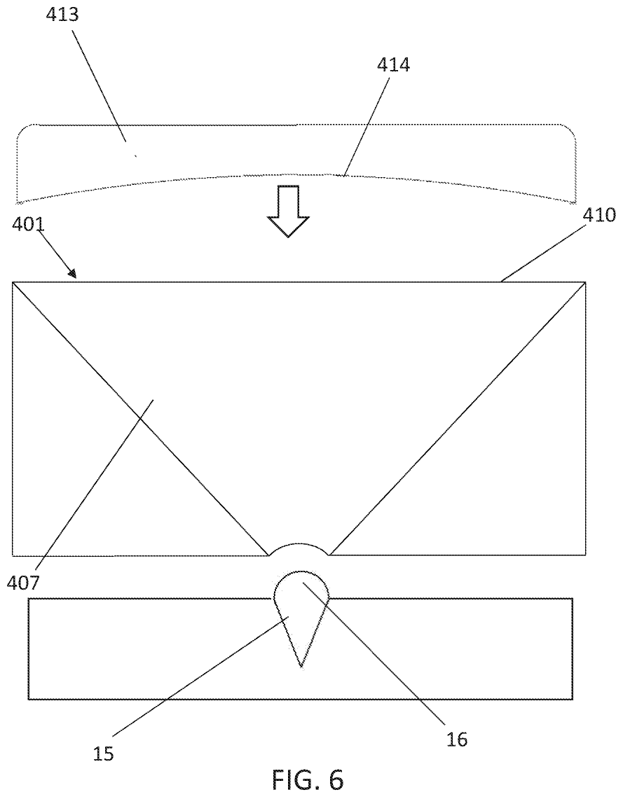

FIG. 6 shows a variant of the component along with a variant of the projectile, in accordance with an embodiment of the invention.

The component 401 in FIG. 6 has a flat input face 410 and is configured to be used with a projectile 413 having a concave impacting surface 414. Striking a flat component input face 410 with a concave projectile impacting surface 414 has a similar effect to striking a concave input face 10 with a flat projectile impacting surface 14. In the illustrated embodiment, the projectile 413 is at least partially formed of tantalum, but may be formed of other heavy metals such as tungsten, platinum, steel, or copper.

Since the impacting surface 414 is concave, the projectile 413 strikes the perimeter of the input face 410 before it strikes the centre. This acts to give the resultant shock in the component 401 a curved front due to the differences in shock and particle velocities in the different stages of the process. The projectile 413 is travelling at speed X, and drives a shock in the volume fill material 407 at each position it impacts with a shock velocity of Y. Y is greater than X, and as such, owing to the curvature of the projectile impacting surface 414, the shock is travelling faster at the edge of the component than the projectile 413 is travelling on the central axis, and thus will be further into the component 401 by the time of projectile impact on the central axis. This helps to give the shock a degree of spherical focusing.

It may be preferable to provide the curve on the projectile impacting face 414, rather than on the component input face 410. This is because, if the projectile 13 is flat on impact and the component input face 10 is concave (as shown, for example, in FIG. 2), a curved shock will be created (as the shock speed is higher than the projectile velocity), but the projectile interface will curve the other way, filling the space formed by the concave input face 10 (as the particle velocity is less than the projectile velocity). By contrast, providing the concave face on the projectile 413 rather than on the component input face 410 (e.g. as shown in FIG. 6), will leave a projectile impacting surface 414 that is still concave after impact, which may be preferable for subsequent reverberations.

Although such embodiments are envisaged, it may not be preferable to have a concave surface on both the projectile and the component input surface, since this may result in the formation of a jet that propagates from the initial impact point on the perimeter towards the central axis that compromises the shock shape.

FIG. 7 shows a variant of the component 201 from FIG. 4, in accordance with an embodiment of the invention.

The component 501 shown in FIG. 7 has a similar construction to the component 201 shown in FIG. 4, but instead has a flat input face 510 such that the component 501 may be configured to be used with a projectile having a concave impacting surface (e.g. as shown in FIG. 6).

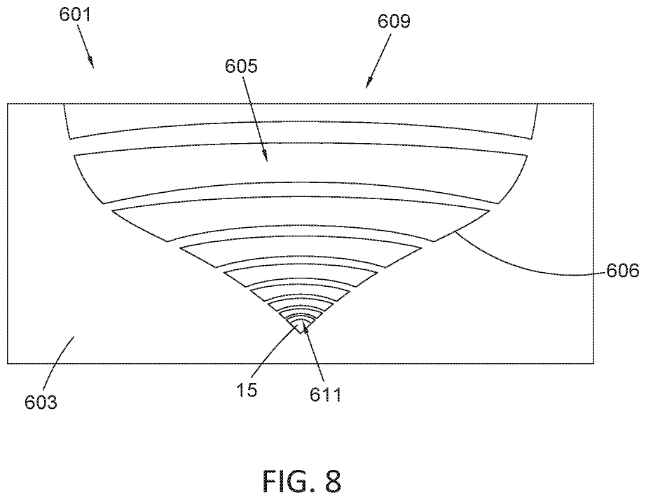

FIG. 8 shows a variant of the component shown in FIG. 7, in accordance with an embodiment of the invention. The component 601 shown in FIG. 8 functions in substantially the same way as described above in relation to FIGS. 4 and 7, but the volume body 603 is shaped such that the angle that the wall 606 makes with a central axis of the volume varies continuously (e.g. is curved) from the input 609 to the output 611. In the illustrated embodiment, the gradient of the wall 606 is greater closer to the output 611 and the input 609, but reduces between the output 611 and input 609.

The angle of the wall 606 varies through the volume 605 in order to account for the fact that the shock flow direction is changing as the shockwave propagates through the volume 605. By varying the wall angle accordingly, the shock reflection from the wall 606 may be improved.

In the embodiment of FIG. 8, the target 15 is defined by the body 603. The output 611 of the volume is coincident with the input to the target 15, with the boundary forming a spherical section. Owing to the shaping of the shock by the component 601, the face of the output 611 and the input face of the target 15 is approximately parallel to the shock-front at that position. This helps to couple the shock into the target 15, thus helping to deliver a spherically converging shock-front into the target 15, which helps to increase the concentration of energy in the target 15.

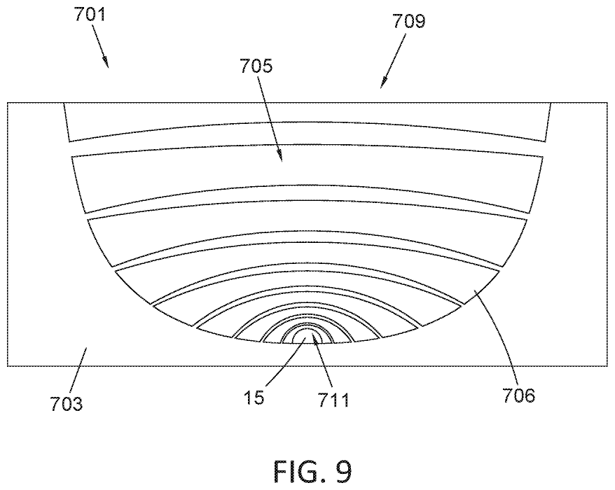

FIG. 9 shows a variant of the component shown in FIG. 8, in accordance with an embodiment of the invention. The component 701 shown in FIG. 9 functions in substantially the same way as described above in relation to FIGS. 4, 7 and 8, but the volume body 703 is shaped such that the angle of the wall varies continuously (e.g. is curved) from the input 709 to the output 711. In the illustrated embodiment, the gradient of the wall 706 is greater close to the input 679, and reduces continuously towards the output 711 such that the volume 705 is approximately bowl shaped.

It can be seen clearly from FIG. 9 that the radii of curvature of the input faces and output faces of the layers decreases progressively from the input 709 to the output 711. This is to account for the fact that as the shockwave reaches the output 711, the shock-front is approximately hemispherical.

As with the embodiment of FIG. 8, in the embodiment of FIG. 9, the target 15 is defined by the body 703. The target 15 shown in FIG. 9 has a spherical cap, but is not conic, and instead takes the shape of a hemisphere.

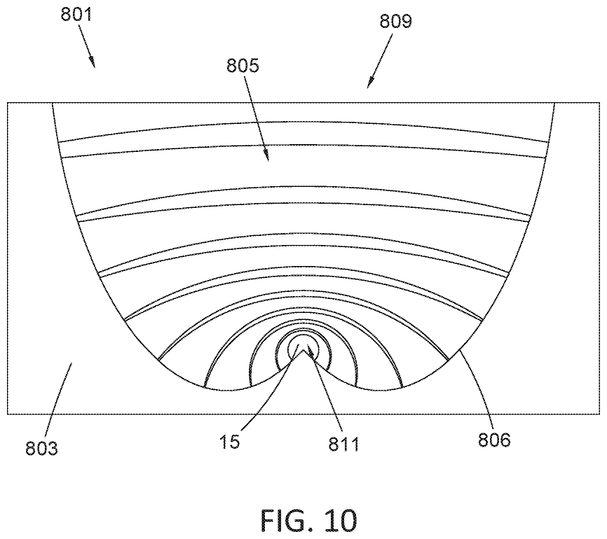

FIG. 10 shows a variant of the component shown in FIG. 8, in accordance with an embodiment of the invention. The component 801 shown in FIG. 10 functions in substantially the same way as described above in relation to FIGS. 4, 7 and 8, but the volume body 803 is shaped such that the angle of the wall varies continuously (e.g. is curved) from the input 809 to the output 811. In the illustrated embodiment, the volume 805 is approximately bowl shaped, but proximal to the output 811, the wall 806 gradually transitions back towards the input 809, with the tip of the inversion aligned with the central axis of the volume 805. The target 15 is defined at the tip of the inversion. As can be seen from FIG. 10, a vertical cross section taken through the volume 805 forms an approximate curved “W” shape. The inverted portion of the wall 806 allows the shockwave in the volume 805 to curve around the target 15, meaning that the target is impacted by the shockwave across approximately 270 degrees.

It can be seen clearly from FIG. 10 that the radii of curvature of the input faces and output faces of the layers decreases progressively from the input 809 to the output 811. This is to account for the fact that as the shockwave reaches the output 811, the shock-front is approximately spherical.

As with the embodiment of FIG. 8, in the embodiment of FIG. 10, the target 15 is defined by the body 803. The target 15 shown in FIG. 9 has a spherical cap, but is not conic, and instead is approximately spherical.

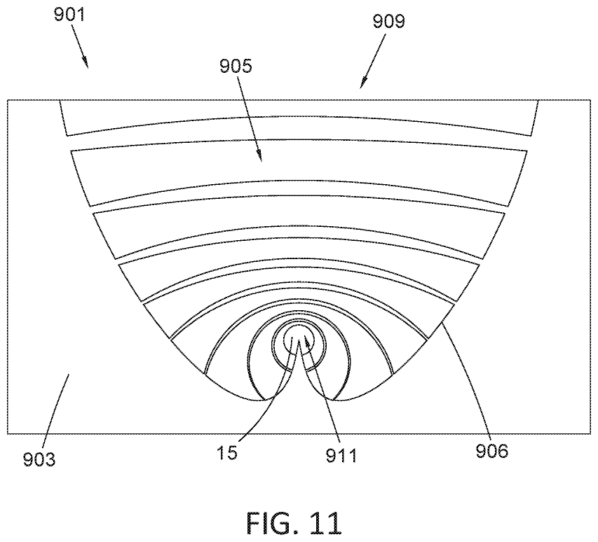

FIG. 11 shows a variant of the component shown in FIG. 8, in accordance with an embodiment of the invention. The component 901 shown in FIG. 11 functions in substantially the same way as described above in relation to FIGS. 4, 7 and 8, but the volume body 903 is shaped such that the angle of the wall varies continuously (e.g. is curved) from the input 909 to the output 911. In the illustrated embodiment, the volume 905 is approximately bowl shaped, but proximal to the output 911, the wall 906 gradually transitions back towards the input 909, with the tip of the inversion aligned with the central axis of the volume 905. The target 15 is defined at the tip of the inversion. As can be seen from FIG. 11, a vertical cross section taken through the volume 905 forms an approximate curved “W” shape. The inverted portion of the wall 906 allows the shockwave in the volume 905 to curve around the target 15, meaning that the target is impacted by the shockwave across approximately 330 degrees.

It can be seen clearly from FIG. 11 that the radii of curvature of the input faces and output faces of the layers decreases progressively from the input 909 to the output 911. This is to account for the fact that as the shockwave reaches the output 911, the shock-front is approximately spherical.

As with the embodiment of FIG. 8, in the embodiment of FIG. 11, the target 15 is defined by the body 903. The target 15 shown in FIG. 9 has a spherical cap, but is not conic, and instead is approximately spherical. !!!!!! make sure “W” shape of FIG. 11 is covered explicitly . . .

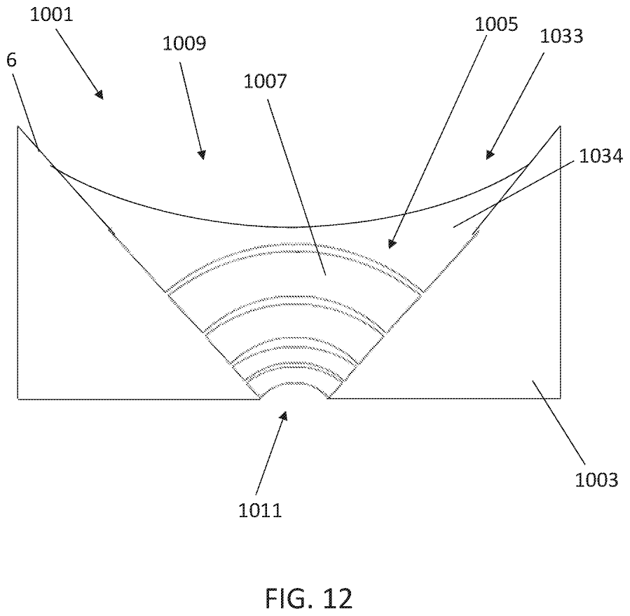

FIG. 12 shows a variant of the component shown in FIG. 4, in accordance with an embodiment of the invention.

The layer 1033 at the input 1009 is a vacuum. In embodiments, the layer 1033 may not be a vacuum, and may instead contain a gas. The first non-vacuum filled layer 1034 in the volume 1005 is preferably a low shock-impedance layer. This is because a first non-vacuum filled layer formed from a high shock-impedance layer may result in a larger portion of the shockwave being reflected by the first non-vacuum filled layer, and hence not transmitted into the rest of the component 1001. However, the alternative is also envisaged.

In the embodiment of FIG. 12, at first, the impacting projectile (e.g. when used in a system similar to that shown in FIG. 2) only strikes the body 1003 of the component 1001 directly. This leads to the generation of an axially converging shock reflection within the projectile, that passes into the volume fill material 1007 when the front face of the projectile contacts the first non-vacuum filled layer 1034. These transmitted-reflected shocks subsequently superimpose on the central axis within the volume 1005, leading to the generation of a high pressure state that expands as a Mach stem towards the output 1011. It is preferable that the projectile 13 is smaller than the volume input 1009 such that the edges of the projectile first strike the wall 1006. The function of the volume 1005 and the subsequent layers, is as described above in relation to FIG. 4.

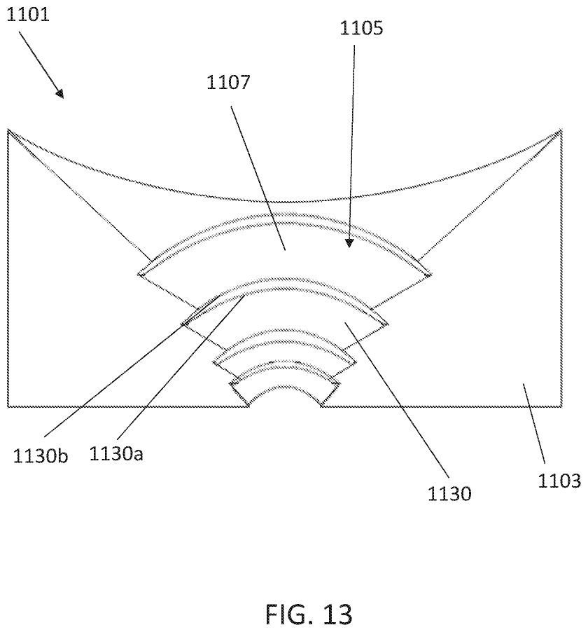

FIG. 13 shows a variant of the component shown in FIG. 4, in accordance with an embodiment of the invention, in which the volume 1105 of the component 1101 has a different shape.

In the embodiment of FIG. 13, the cross sectional area of the input face 1130a of each low shock-impedance layer 1130 is greater than the cross sectional area of the output face 1130b of the preceding low shock-impedance layer 1130.

The component 1101 shown in FIG. 13 functions in substantially the same way as described above in relation to FIG. 4, but the overlapping output faces 1130b and subsequent input faces 1130a enable shocks that are transmitted from the volume fill material 11011 into the body 1103 of the component 1101 to be partially recaptured by the input face 1130a of the subsequent low shock-impedance layer 1130, and focused back into the volume fill material 1107. This may lead to a reduced amount of shock loss and hence a more efficient component 1101. Further, since the low shock-impedance layers 1130 are discrete, the different layers 1130 can have different properties such as input diameter, output diameter, thickness, material, and wall angle.

Although specific examples have been given, it will be appreciated that there are a large number of parameters that may influence the actual results achieved.

In each of the embodiments described above, the diagrams shown are a vertical cross-section through a three-dimensional component and hence they depict embodiments that are rotationally symmetric. However, this is not essential to the invention.

It will be understood that the embodiments explicitly disclosed herein are intended to be exemplary, and the skilled person will understand that features of the embodiments disclosed herein may, except where mutually exclusive, be combined in combinations not explicitly mentioned in order to form new embodiments.

Although the input faces of the components shown in the illustrated embodiments are flat or concave, it will be appreciated that embodiments exist in which the input face is at least partially convex.

It will be appreciated that embodiments exist in which one or more of the (e.g. high shock-impedance) layers tapers to zero, e.g. at the centre and/or edges of the layer(s).

It will be appreciated that embodiments exist in which one or more of the (e.g. high shock-impedance) layers comprises one or more apertures through the layer(s), e.g. which aperture(s) are aligned with aperture(s) in the other (e.g. adjacent) layer(s).

Embodiments of the invention may be suitable for amplifying shockwaves for the purpose of generating conditions suitable for nuclear fusion; however, the invention is not limited to this, and may be used for other applications, for example, the testing of safety equipment such as crash helmets.

1. A component for manipulating an input shockwave, wherein the component comprises:
a body comprising a first material;
a volume defined within the body, wherein the volume is configured to manipulate the input shockwave so as to produce a manipulated shockwave;
wherein the volume comprises:
an input for receiving the input shockwave incident upon the component;
an output for outputting the manipulated shockwave from the volume; and
a plurality of layers between the input and the output;
wherein the plurality of layers comprises one or more layers comprising a second material that is different from the first material; and
wherein the plurality of layers comprises one or more layers having an input face and/or an output face comprising a non-planar portion.

2. The component as claimed in claim 1, wherein the second material has a shock-impedance that is lower than a shock-impedance of the first material.

3. The component as claimed in claim 1, wherein the plurality of layers comprises one or more layers having a non-uniform thickness.

4. The component as claimed in claim 1, wherein the plurality of layers comprises one or more layers having an input face comprising a convex portion.

5. The component as claimed in claim 4, wherein multiple layers of the plurality of layers have an input face comprising a convex portion, and the radius of curvature of the convex portions decreases from the input to the output.

6. The component as claimed in claim 1, wherein the plurality of layers comprises one or more layers having an output face comprising a concave portion.

7. The component as claimed in claim 6, wherein multiple layers of the plurality of layers have an output face comprising a concave portion, and the radius of curvature of the concave portions decreases from the input to the output.

8. The component as claimed in claim 1, wherein the layer at or adjacent the output of the volume has an output face comprising a concave portion.

9. The component as claimed in claim 1, wherein the layer at or adjacent the input of the volume has an input face comprising a concave portion.

10. The component as claimed in claim 1, wherein the layer at or adjacent the input of the volume has an output face comprising a concave portion.

11. The component as claimed in claim 1, wherein the plurality of layers comprises at least one first layer and at least one second layer, wherein the at least one first layer comprises a third material, and the at least one second layer comprises the second material.

12. The component as claimed in claim 11, wherein the third material has a higher shock-impedance than the shock-impedance of the second material.

13. The component as claimed in claim 12, wherein at least one first layer has a non-uniform thickness.

14. (canceled)

15. The component as claimed in claim 1, wherein the body is shaped such that a cross-sectional area of the input is greater than a cross sectional area of the output.

16. The component as claimed in claim 1, wherein the volume comprises two or more sections that are at different respective angles to a central axis of the volume.

17. The component as claimed in claim 16, wherein the volume comprises a first sub-volume and a second sub-volume arranged between the input of the volume and the output of the volume;
wherein the first sub-volume comprises an input and an output;
wherein the second sub-volume comprises an input and an output; and
wherein the body is shaped such that a cross sectional area of the output of the first sub-volume is less than a cross sectional area of the input of the second sub-volume.

18. A component for manipulating an input shockwave, wherein the component comprises:
a body comprising a first material; and
a volume defined within the body, wherein the volume is configured to manipulate the input shockwave so as to produce a manipulated shockwave;
wherein the volume comprises:
an input for receiving the input shockwave incident upon the component;
an output for outputting the manipulated shockwave from the volume; and
a plurality of layers between the input and the output;
wherein the plurality of layers comprises one or more layers comprising a second material that is different from the first material; and
wherein the plurality of layers comprises one or more layers having a non-uniform thickness.

19.-20. (canceled)

21. A method of manipulating a shockwave, the method comprising generating at least one shockwave to be incident upon a component according to claim 1.

22. A system for producing a localised concentration of energy comprising:
a component as claimed in claim 1; and
a mechanism for generating at least one shockwave propagating through the component.

23. The system as claimed in claim 22, wherein the mechanism comprises a driving mechanism configured to drive a projectile into the component to generate a shockwave at the input of the component.

24.-25. (canceled)
